(19) United States
(12) Patent Application Publication
(10) Pub. No.: US 2012/0296097 A1
(43) Pub. Date: Nov. 22, 2012

(54) PREPARATION METHOD OF ORIGINAL DYE OF VAT BROWN R

(76) Inventors: Dezhi Xiang, Xuzhou (CN); Dejun Yan, Xuzhou (CN); Chongli Xu, Xuzhou (CN); Ying Shao, Xuzhou (CN); Ping Fu, Xuzhou (CN); Hongwei Wang, Xuzhou (CN); Shunli Su, Xuzhou (CN); Jiarong Wei, Xuzhou (CN); Changjing Wang, Xuzhou (CN); Qinghe Shang, Xuzhou (CN); Jian Li, Xuzhou (CN); Yan Dou, Xuzhou (CN); Hui Du, Xuzhou (CN); Jinchao Miao, Xuzhou (CN); Hui Liu, Xuzhou (CN); Yongwei Li, Xuzhou (CN); Lianfeng Li, Xuzhou (CN); Yongmei Xu, Xuzhou (CN); Mei Zhang, Xuzhou (CN); Xianxu Zhang, Xuzhou (CN)

(21) Appl. No.: 13/516,775

(22) PCT Filed: Dec. 17, 2009
(86) PCT No.: PCT/CN2009/075660

§ 371 Date: Aug. 2, 2012

(51) Int. Cl. C09B 5/28

(52) U.S. Cl. 548/416

(57) ABSTRACT

A preparation method of original dye of Vat Brown R comprises the following steps: a. after acylation of 1,5-diaminoanthraquinone, 1-amino-5-benzamidoanthraquinone was prepared by acidic hydrolysis; b. 1-benzamido-4-bromoanthraquinone was obtained from 1-aminoanthraquinone by acylation and bromination; c. a condensate of Vat Brown R was obtained by condensation reaction of 1-amino-5-benzamidoanthraquinone and 1-benzamido-4-bromoanthraquinone; d. the original dye of Vat Brown R was obtained from the condensate of Vat Brown R by ring closing reaction and oxidation reaction. The method omits one oxidation step, economizes significant amount of oxidizing agent, and reduces significant amount of waste water, so it is very beneficial to environment protection; and the method also exhibited the advantages of highly increasing product yield and reducing the costs of raw materials to an extent of more than 30%.

### FIELD OF THE INVENTION

The present invention belongs to the technical field of dyes and relates to a method for preparing anthraquinone vat dyes, particularly to a method for producing vat brown R.

### BACKGROUND OF THE INVENTION

Vat brown R is an important brown variety of vat dyes. Following the changes of the market, the defect of low yield and high consumption of the original production process is becoming more evident. Furthermore, the environmental protection regulations are getting stricter. The current production capacity of vat brown R is unable to meet the demands of domestic and foreign markets (in particular product export). Conventional process route of vat brown R is:
(1) 1,5-diaminoanthraquinone is acylated to obtain acylate (I) (containing about 54% of 1-amino-5-benzamidoanthraquinone, 46% of 1,5-dibenzamidoanthraquinone and less than 0.5% of unreacted 1,5-diaminoanthraquinone).
(2) 1-aminoanthraquinone is acylated, brominated and filtered to obtain acylated bromide (II).
(3) (I) and (II) undergo condensation, distillation, filtering, washing, drying, ring closing, primary oxidation, filtering, washing, secondary oxidation, filtering, washing and drying.
1. Problem with the synthesis of 1-amino-5-benzamidoanthraquinone (monoacylate):

1,5-diaminoanthraquinone is acylated in nitrobenzene. While 1-amino-5-benzamidoanthraquinone (monoacylate) is obtained, almost a same amount (weight) of 1,5-dibenzamidoanthraquinone (diacylate) is generated. Even if the amount of the acylating agent is controlled and the acylation method is changed, the amount of the obtained monoacylate will not exceed 60%, wherein only monoacylate is a useful intermediate of vat brown R, while diacylate exists in the dye as an impurity and its existence will cause low strength and dark shade of the dye. It must be removed through secondary oxidation. In such a way, not only the yield is low but also the energy consumption is high.

To solve this problem, the conventional method is to separate the acylate mixture generated from the reaction so as to obtain useful monoacylate and byproduct diacylate respectively, and then hydrolyze diacylate into 1,5-diaminoanthraquinone raw material. In such a way, the raw material is effectively used and the cost is reduced. Generally, the acylate mixture is separated based on different solubilities of monoacylate and diacylate in nitrobenzene at 120° C. (monoacylate is soluble in hot nitrobenzene, while diacylate is not). Then the separated diacylate is hydrolyzed into 1,5-diaminoanthraquinone at high temperature and high pressure under alkaline condition. After dried, it is recycled. This process can sufficiently use the main reactant, but the environment of separation operation is too harsh, the process condition of alkaline hydrolysis is too strict (high temperature and high pressure) and the reaction time is too long, so it is difficult to implement. The process route is shown in FIG. 1.

After literature search, it is found that Japanese patent JP9-268168 (1997) relates diacylate hydrolysis by acidic hydrolysis. The prerequisite of hydrolysis is a separation of monoacylate and diacylate. Then only diacylate is hydrolyzed into monoacylate in sulfuric acid. The purity of the obtained product is not high, at most.83 wt % The separation of monoacylate and diacylate needs to be conducted in nitrobenzene at 120° C. Nitrobenzene is a highly toxic chemical, which is especially harmful at high temperature. Therefore, it is difficult to produce monacylate in practice by the method provided by this patent:

Compared to JP9-268168, the acidic hydrolysis method provided by the present invention has enormous superiority as reflected in the following two points: firstly, there is no need to separate monoacylate and diacylate. Secondly, the obtained monoacylate has high purity, above 90 wt % in the hydrolysate.
2. Problem with the conditions of condensation reaction:

In the existing production processes, the condensation reaction requires holding the temperature at 210° C. for 10 hours. The energy consumption is high, work efficiency is low and environmental pollution is serious. In addition to useful 1-amino-5-benzamidoanthraquinone (monoacylate), the hydrolysis of acylates also generates a small amount of 1,5-diaminoanthraquinone. During condensation, it is also possible that 1-amino-5-benzamidoanthraquinone removes benzoyl to generate 1,5-diaminoanthraquinone which may cause dark shade of the dye.
3. The solvent used in the condensation step is nitrobenzene solvent, which is carcinogenic and scorbutic.
4. After twice oxidation, the yield of product is low.

### SUMMARY OF THE INVENTION

Objects of the Invention

To address the above technical defects, the present invention has the following objects:
1. During the production of original dye of vat brown R, the acylates of 1,5-diaminoanthraquinone (a mixture of monoacylate and diacylate) are hydrolyzed at low temperature under an acidic condition without separation, thereby the yield of 1-amino-5-benzamidoanthraquinone is increased.
2. During the production of original dye of vat brown R, 1-amino-5-benzamidoanthraquinone and 1-benzamido-4-bromoanthraquinone are condensed in an organic solvent under the condition that copper powder or copper salt as catalyst in the presence of an acid binding agent, then ring closing by sulfuric acid and oxidation with an oxidizing agent, original dye of vat brown R is obtained.
3. During the production of original dye of vat brown R, the energy consumption of vat brown R condensation reaction can be reduced, efficiency thereof can be improved and process thereof can be shortened.
4. The original dye of vat brown obtained from the production process of the present invention has improved shade and product quality.
5. During the production of original dye of vat brown R, the highly toxic solvent nitrobenzene can be replaced with a solvent with low toxicity.
6. Product yield is increased through the process of the present invention.

### Technical Scheme

A method for producing original dye of vat brown R, comprising the following process steps: a. 1,5-diaminoanthraquinone, 1-amino-5-benzamidoanthraquinone is prepared by acidic hydrolysis after acylation; b. 1-benzamido-4-bromoanthraquinone is obtained from 1-aminoanthraquinone by acylation and bromination; c. a condensate of vat brown R is obtained by the condensation reaction of 1-amino-5-benzamidoanthraquinone and 1-benzamido-4-bromoanthraquinone; d. the original dye of vat brown R is obtained from ring closing and oxidation of the condensate of vat brown R.

A method for producing original dye of vat brown R, a. Preparation of 1-amino-5-benzamidoanthraquinone: adding 1,5-diaminoanthraquinone acylation mixture into 80˜98 wt % sulfuric acid at a mass ratio of 6˜12: 1 between sulfuric acid and 1,5-diaminoanthraquinone acylation mixture, adjusting the temperature of the obtained reaction system to the range of 15 to 45° C., holding the temperature for 1 to 4 hours, take samples, determining the content of 1-amino-5-benzamidoanthraquinone, 1,5-dibenzamidoanthraquinone and 1,5-diaminoanthraquinone by HPLC, identifying the end point of the reaction when the mass percentage of 1,5-dibenzamidoanthraquinone is no more than 5% in the entire reaction system, after arrival at the end point, neutralizing the reaction product by diluting, filtering and washing, and drying it to obtain the hydrolysate; b. Preparation of vat brown R condensate: adding the hydrolysate prepared in the above step into o-dichlorobenzene, raising the temperature to the range of 110 to 150° C. for dehydration, adding an acid binding agent, holding the temperature for 0.5 to 2 hours, then raising the temperature to the range of 150 to 155° C., adding benzoyl chloride, holding the temperature at the range of 150 to 155° C. for 1 to 2 hours, adding acylated bromide filter cakes (which are 1-benzamido-4-bromoanthraquinone obtained from 1-aminoanthraquinone by acylation and bromination and contains 1-benzamido-4-bromoanthraquinone no less than 95 wt %) and the acid binding agent, raising the temperature to the range of 170 to 185° C., adding copper catalyst, condensing at the temperature of 170 to 185° C. for 2 to 6 hours, taking samples, determining the content by HPLC, identifying the end point of the condensation reaction when the remaining amount of 1-benzamido-4-bromoanthraquinone in the reaction product is no more than 1 wt % and that of 1-amino-5-benzamidoanthraquinone is no more than 1 wt %, removing o-dichlorobenzene through distillation after the condensation, then neutralizing the condensation product by filtering and washing, and drying it to obtain black vat brown R condensate; c. Preparation of the ring-closed product of vat brown R: adding black vat brown R condensate into 80˜98 wt % sulfuric acid, adjusting the temperature of the reaction system to the range of 15 to 35° C., holding the temperature for 5 to 10 hours, then diluting the materials in the reaction system, and neutralizing the reaction product by filtering and washing to obtain the ring-closed product of vat brown R; d. Oxidation step: adding sulfuric acid into water, controlling the concentration of sulfuric acid at 20˜40 wt %, then adding the ring-closed product of vat brown R, mixing and stirring them for 0.5 to 2 hours, then raising the temperature to the range of 50 to 80° C., adding an oxidizing agent which is selected from the group consisted of sodium chloride, sodium dichromate or potassium dichromate, then raising the temperature to the range of 80 to 95° C., adding the water solution of the above oxidizing agent drop by drop (the mass ratio between the added oxidizing agent and the ring-closed product of vat brown R is 1: (1˜2.5)), holding the temperature for 2 to 6 hours, neutralizing the reaction product by filtering and washing, and drying it to obtain dark red original dye of vat brown. The foregoing 1,5-diaminoanthraquinone acylation mixture is a mixture of 1-amino-5-benzamidoanthraquinone and 1,5-dibenzamidoanthraquinone at a mass ratio of 54:46. In step b, the amount of the acid binding agent added in the first time is from 1 to 3 times of the molar amount of the hydrolysate, the amount of the acid binding agent added in the second time is from 1 to 6 times of the molar amount of 1-benzamido-4-bromoanthraquinone, and the acid binding agent is one of sodium carbonate, sodium bicarbonate, potassium carbonate, magnesium oxide, calcium oxide, sodium acetate and pyridine or a mixture of any two of them at any ratio. In step a, the temperature of sulfuric acid is in the range of 5 to 15° C.

In step b, the molar ratio between 1-benzamido-4-bromoanthraquinone and hydrolysate is 1: (1˜0.5); the molar ratio between 1-benzamido-4-bromoanthraquinone and benzoyl chloride is no more than 5:1; the molar ratio between 1-benzamido-4-bromoanthraquinone and copper catalyst is 1: (0.02˜0.08)); and the mass of solvent o-dichlorobenzene is from 5 to 10 times of the mass of all the materials in the reaction system.

In step c, the temperature of sulfuric acid is in the range of 5 to 20° C.

In step c, the consumption of sulfuric acid is 4˜8 times of the mass of black vat brown R condensate.

The applicant has made in-depth analysis and research on the reactions of vat brown R at every step. Now the improvements to the synthesis process are explained below:

1. Improvement to the Synthesis of 1-amino-5-benzamidoanthraquinone (monoacylate)

The applicant has improved the hydrolysis process of acylates, i.e. abandoning alkaline hydrolysis and adopting acidic hydrolysis, with the following operating steps: adding 1,5-diaminoanthraquinone acylation mixture into 80-98 wt % sulfuric acid, adjusting the temperature of the obtained reaction system to the range of 15 to 45° C., holding the temperature for 1 to 4 hours, determining the content of 1-amino-5-benzamidoanthraquinone, 1,5-dibenzamidoanthraquinone and 1,5-diaminoanthraquinone by HPLC, identifying the end point of the reaction when the mass percentage of 1,5-dibenzamidoanthraquinone is no more than 5% in the entire reaction system, neutralizing the reaction product by diluting, filtering and washing after arrival at the end point and drying it to obtain the hydrolysate. The content of 1-amino-5-benzamidoanthraquinone in the entire system is no less than 90%. The vat brown R obtained from this hydrolysate through condensation, ring closing and oxidation has bright shade. Its strength reaches the range of 300 to 330%, whereas the strength of vat brown R obtained from the traditional process is only in the range of 220 to 260%.

This hydrolysis method features with moderate reaction conditions, short time (the normally hydrolysis takes for 1 to 4 hours at normal temperature), and high product purity, superior to the similar products in the market. The process route is shown in FIG. 2.

### 2. Improvement to Condensation Reaction Conditions

i. Through purifying major reaction raw material (1-amino-5-benzamidoanthraquinone) and replacing nitrobenzene having a high boiling point with o-dichlorobenzene having a low boiling point, the temperature of condensation reaction are improved from holding the temperature at 210° C. for 10 hours to holding the temperature at the range of 170 to 185° C. for the range of 2 to 6 hours. This improvement not only lowers energy consumption and improves environment but also greatly raises work efficiency.
ii. In addition to useful 1-amino-5-benzamidoanthraquinone (monoacylate), the hydrolysis of acylates also generates a small amount of 1,5-diaminoanthraquinone. During condensation, it is also possible that 1-amino-5-benzamidoanthraquinone removes benzamido to generate 1,5-diaminoanthraquinone which may cause dark shade of the dye. Adding a small amount of benzoyl chloride during reaction can significantly improve the shade of the dye and product quality.

### 3. Solvent Screening in the Condensation Step

O-dichlorobenzene solvent with low toxicity is used instead of carcinogenic and scorbutic nitrobenzene solvent, realizing clean production.

### 4. Avoiding the Step of Secondary Oxidation

It is shown that the quality of the product after primary oxidation is similar to the quality of the standard substance after the purity of the raw materials for condensation is improved, so the step of secondary oxidation is avoided to save a large amount of oxidizing agent, raise product yield and reduce sewage discharge. Through the above process improvement, the produced vat brown R product has excellent quality, high strength and bright shade. The yield is raised and the cost of the raw materials is reduced by more than 30%.

New process route:
(1) 1,5-diaminoanthraquinone undergoes acylation, distillation, filtering, washing, drying, hydrolysis, dilution, filtering, washing and drying to obtain monoacylate (I).
(2) 1-aminoanthraquinone undergoes acylation, bromination and filtering to obtain acylated bromide (II).
(3) (I) and (II) undergoes condensation, distillation, filtering, washing, drying, ring closing, oxidation, filtering, washing and drying to obtain original dye.

The reaction equations in each step are described as follows:

Acylation of 1,5-diaminoanthraquinone:

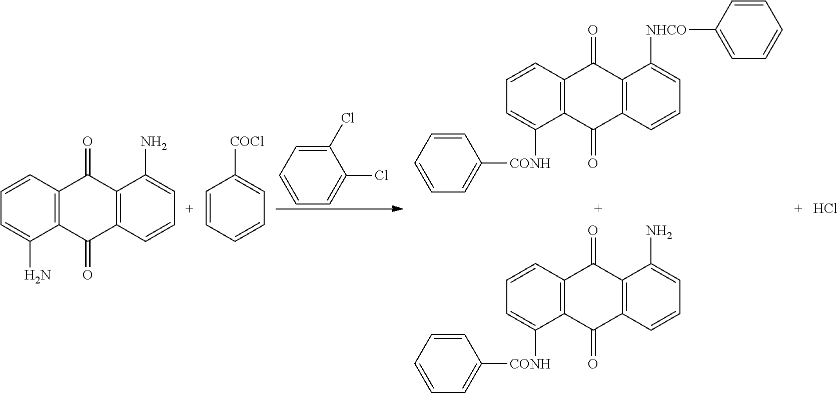

Hydrolysis:

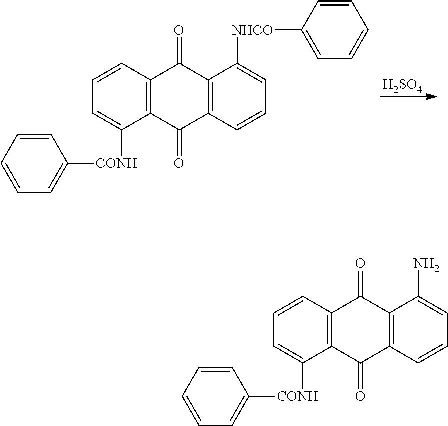

Acylation and bromination of 1-aminoanthraquinone:

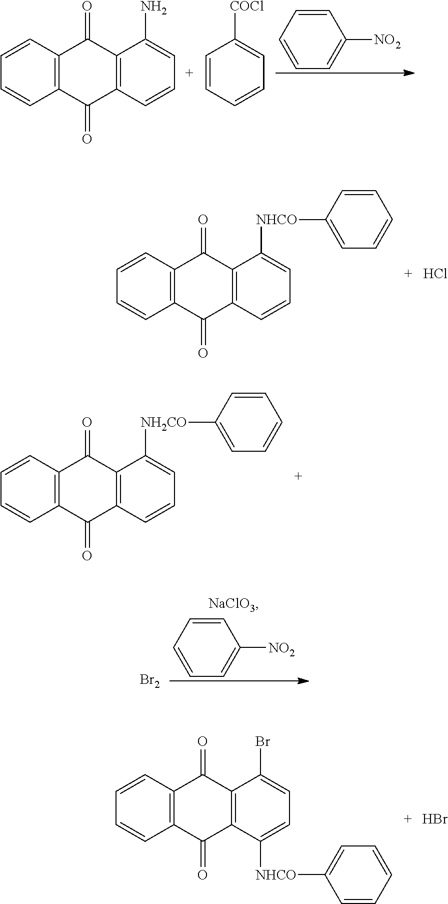

Condensation:

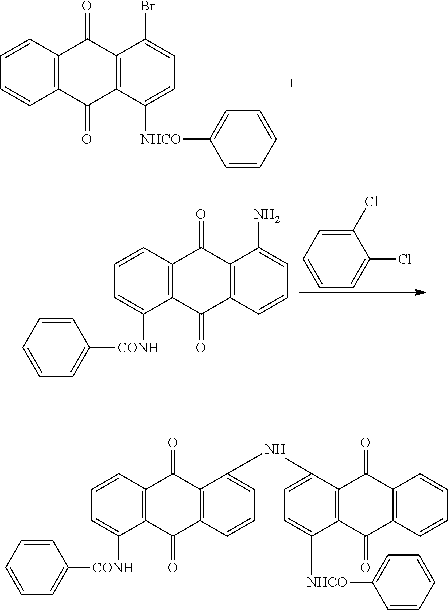

Ring Closing and Oxidation:

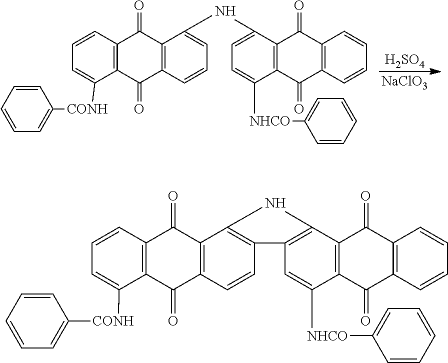

Beneficial Effects:

1. The mixture of 1-amino-5-benzamidoanthraquinone and 1,5-dibenzamidoanthraquinone is hydrolyzed under acidic condition. They are directly hydrolyzed in sulfuric acid without separating them at high temperature in a highly toxic solvent in advance. The desired 1-amino-5-benzamidoanthraquinone is retained, while the undesired 1,5-diaminoanthraquinone is hydrolyzed into the desired 1-amino-5-benzamidoanthraquinone, rather than 1,5-diaminoanthraquinone in alkaline hydrolysis. The acidic hydrolysis is the most economical and practical hydrolysis method. The purity of 1-amino-5-benzamidoanthraquinone obtained by the acidic hydrolysis method is high, so the final product vat brown R has good shade and high yield.

2. In the production process of condensation, heating with oil is adopted. In the traditional production process, held the temperature at the range of 205 to 210° C. for 10 minutes and then lowered to 180° C. This process needs more than 10 hours and consumes a large amount of energy. After improvement, the temperature of the condensation reaction is lowered to the range of 170 to 185° C., the reaction time is shortened, so the energy saving effect is significant.

3. Adding a small amount of benzoyl chloride during reaction can significantly improve the shade of the dye and product quality.

4. The abandonment of the conventional process in which nitrobenzene with high toxicity and high boiling point is used as a solvent reduces the emission of toxic and harmful gas, which is conducive to the environment and operators' health on the site, saves a large amount of energy and shows desirable economic and social benefits.

5. The deletion of one oxidation step saves a large amount of oxidizing agent, reduces a large amount of wastewater discharge and is very helpful to environmental protection. Meanwhile, the product yield is greatly improved and the cost of raw materials is reduced by more than 30%.

### BRIEF DESCRIPTION OF THE DRAWINGS

FIG. 1 is a flow diagram of the synthesis of 1-amino-5-benzamidoanthraquinone (monoacylate).

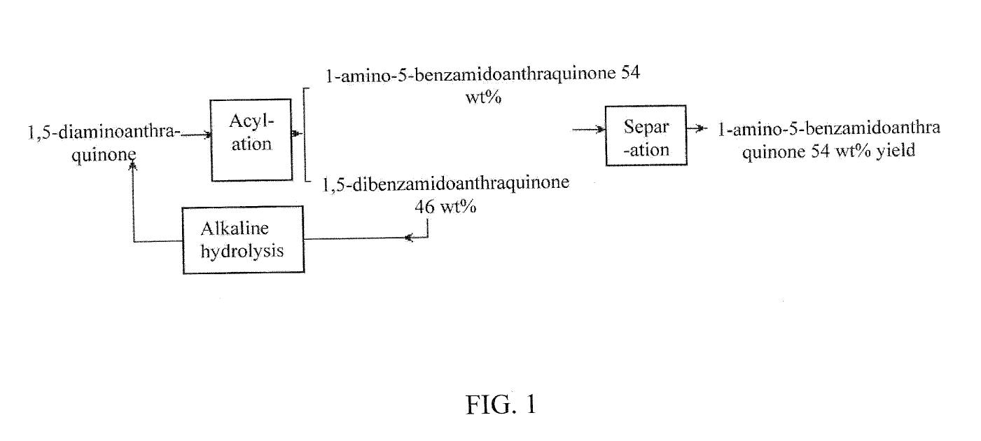

FIG. 2 is an improved flow diagram of the synthesis of 1-amino-5-benzamidoanthraquinone (monoacylate).

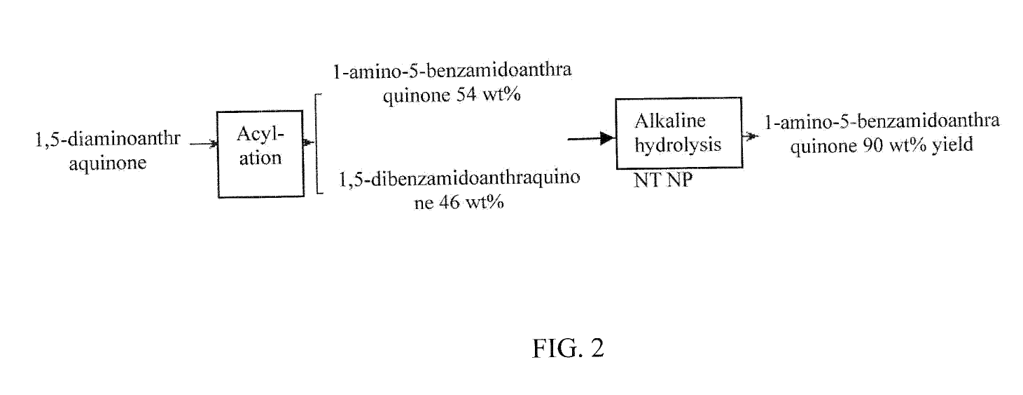

### DETAILED DESCRIPTION OF THE EMBODIMENTS

Below the present invention is further illustrated combining concrete embodiments. These embodiments are intended to illustrate the present invention but not to limit the scope of the present invention.

### Embodiment 1

Add 110 mL of 90˜98 wt % sulfuric acid into a 250 mL of three-neck flask (with a thermometer and a stirrer), start stirring, reduce the temperature in an ice-bath to below 15° C., add 18 g of 1,5-diaminoanthraquinone acylation mixture, remove the ice-bath after the addition, adjust the temperature to the range of 10 to 45° C., hold the temperature for 1 to 4 hours, take samples, determine the content of 1-amino-5-benzamidoanthraquinone, 1,5-dibenzamidoanthraquinone and 1,5-diaminoanthraquinone by HPLC, and identify the end point of the reaction when the content of 1,5-dibenzamidoanthraquinone is no more than 5 wt %. Dilute the material in 500 mL of water after arrival at the end point, neutralize it by filtering and washing and dry it to obtain 15 g of hydrolysate. It is determined by HPLC that the content of 1-amino-5-benzamidoanthraquinone is 90.30 wt %, that of 1,5-diaminoanthraquinone is 4.52 wt % and that of 1,5-dibenzamidoanthraquinone is 3.95 wt %

### Embodiment 2

Add 120 g of nitrobenzene into a 250 mL of three-neck flask (with a thermometer, a stirrer and a reflux condenser. Cold water is input into the condenser. An exhaust pipe and a tail gas absorber are laid above to remove HCl and HBr that might be generated during the reaction), start stirring, add 7˜7.5 g of the hydrolysate obtained in embodiment I, raise the temperature to the range of 140 to 145° C., add 4 g of sodium carbonate, hold the temperature for 0.5 hour after the addition, raise the temperature to the range of 150 to 155° C., add 0.1˜1 g of benzoyl chloride, and hold the temperature at the range of 150 to 155° C. for 1 to 2 hours. Add 7.5 g of acylated bromide filter cakes (the content of 1-benzamido-4-bromoanthraquinone is more than 95 wt %) and 1.5 g of anhydrous sodium acetate, raise the temperature to the range of 175 to 183° C., add 0.1˜0.5 g of copper powder and then hold the temperature at the range of 175 to 183° C. for 2 to 6 hours. Take samples, determine the content by HPLC and identify the end point of condensation when the remaining content of bromide is no more than 1 wt % and that of monoacylate is no more than 1 wt %. Distill nitrobenzene under reduced pressure at a vacuum degree of −0.06 to 0.08 MPa after the arrival at the end point, adopt steam distillation after most nitrobenzene is distilled out to remove o-dichlorobenzene, neutralize it by filtering and washing, and dry to obtain 16-19 g of black vat brown R condensate.

### Embodiment 3

Add 120 g of o-dichlorobenzene into a 250 mL of three-neck flask (with a thermometer, a stirrer and a reflux condenser. Cold water is input into the condenser. An exhaust pipe and tail gas absorber are laid above to remove HCl and HBr generated during the reaction), start stirring, add 7˜7.5 g of the hydrolysate obtained in embodiment 1, raise the temperature to the range of 140 to 145° C., add 4 g of sodium carbonate, hold the temperature for 0.5 hour after the addition, raise the temperature to the range of 150 to 155° C., add 0.1˜1 g of benzoyl chloride, and hold the temperature at the range of 150 to 155° C. for 1 to 2 hours. Add 7.5 g of acylated bromide filter cakes (the content of 1-benzamido-4-bromoanthraquinone is more than 95 wt %) and 1.5 g of anhydrous sodium acetate, raise the temperature to the range of 175 to 183° C., add 0.1˜0.5 g copper powder and then hold the temperature at the range of 175 to 183° C. for 2 to 6 hours. Take samples, determine the content by HPLC and identify the end point of condensation when the remaining content of acylated bromide is no more than 1 wt % and that of monoacylate is no more than 1 wt %. Distill o-dichlorobenzene under reduced pressure at a vacuum degree of −0.06 to −0.08 MPa after the arrival at the end point, adopt steam distillation after most o-dichlorobenzene is distilled out to remove o-dichlorobenzene, neutralize it by filtering and washing, and dry to obtain 16-19 g of black vat brown R condensate. After the condensate undergoes two steps: ring closing and oxidation, original dye of vat brown is obtained. Compared to Embodiment 2, the strength and shade of the products are similar, suggesting using o-dichlorobenzene instead of nitrobenzene as a solvent during condensation process has no influence on product quality.

### Embodiment 4

Add 120 g of o-dichlorobenzene into a 250 mL of three-neck flask (with a thermometer and a reflux condenser. Cold water is input into the condenser. An exhaust pipe and tail gas absorber are laid above to remove HCl and HBr generated during the reaction), start stirring, add 7˜7.5 g of the hydrolysate obtained in embodiment 1, raise the temperature to the range of 140 to 145° C., add 4 g of sodium carbonate, hold the temperature for 0.5 hour after the addition, raise the temperature to the range of 150 to 155° C., add 0.1˜1 g of benzoyl chloride, and hold the temperature at the range of 150 to 155° C. for 1 to 2 hours. Add 7.5 g of acylated bromide filter cakes (the content of 1-benzamido-4-bromoanthraquinone is more than 95 wt %), 1.5 g of anhydrous sodium acetate and 3 g of magnesium oxide, raise the temperature to the range of 170 to 185° C., add 0.1˜0.5 g copper powder and then hold the temperature at the range of 170 to 185° C. for 2 to 6 hours. Take samples for HPLC and identify the end point of condensation when the remaining content of acylated bromide is no more than 1 wt % and that of monoacylate is no more than 1 wt %. Distill o-dichlorobenzene under reduced pressure at a vacuum degree of −0.06 to −0.08 MPa after the arrival at the end point, adopt steam distillation after most o-dichlorobenzene is distilled out to remove o-dichlorobenzene, neutralize it by filtering and washing, and dry to obtain 15˜19 g of black vat brown R condensate. After the condensate undergoes two steps: ring closing and oxidation, original dye of vat brown is obtained. Compared to Embodiment 3, the strength of the product is raised by 5%, suggesting using composite acid binding agents during condensation process has a better effect.

### Embodiment 5

Add 120 g of o-dichlorobenzene into a 250 mL of three-neck flask (with a thermometer and a reflux condenser. Cold water is input into the condenser. An exhaust pipe and tail gas absorber are laid above to remove the HBr generated during the reaction), start stirring, add 7˜7.5 g of the hydrolysate obtained in embodiment I, raise the temperature to the range of 140 to 145° C., add 4 g of sodium carbonate, hold the temperature for 0.5 hour after the addition, raise the temperature to the range of 150 to 155° C. Add 7˜7.5 g of acylated bromide filter cakes (the solid content is about 60 wt %), 1.5 g of anhydrous sodium acetate and 3 g of magnesium oxide, raise the temperature to the range of 170 to 185° C., add 0.1˜0.5 g of copper powder and then hold the temperature at the range of 170 to 185° C. for 2 to 6 hours. Take samples, determine the content by HPLC and identify the end point of condensation when the remaining content of acylated bromide is no more than 1 wt % and that of monoacylate is no more than 1 wt %. Distill nitrobenzene under reduced pressure at a vacuum degree of −0.06 to −0.08 MPa after the arrival at the end point, adopt steam distillation after most o-dichlorobenzene is distilled out to remove nitrobenzene, neutralize it by filtering and washing, and dry to obtain 15˜19 g of black vat brown R condensate. After the condensate undergoes two steps: ring closing and oxidation, original dye of vat brown is obtained. Compared to Embodiment 4, the shade of the product is poor and the chromatic aberration is as follows: ^{Δ}a=−0.9, ^{Δ}b=−1.23, ^{Δ}c=−0.9.

### Embodiment 6

Add 100 mL of 90˜98 wt % sulfuric acid into a 250 mL of three-neck flask (with a thermometer and a stirrer), start stirring, reduce temperature in an ice-bath to below 20° C., add 30 g of vat brown R condensate obtained in embodiment 2 or 3 or 4, remove the ice-bath after the addition, adjust the temperature to the range of 10 to 45° C., hold the temperature for 5 to 10 hours, then dilute the material in 500 mL of water, and neutralize it by filtering and washing to obtain from 28 to 29.5 g the ring-closed product of vat brown R. Its shade is similar to that of the standard substance, and its strength is 100±5% of that of the standard substance.

### Embodiment 7

Add 200 mL of water into a 500 mL three-neck flask (with a thermometer and a stirrer), start stirring, add 50 mL of 70˜98 wt % sulfuric acid, add 15 g of the ring-closed product obtained in embodiment 6, mix and stir for 0.5 to 2 hours after the addition, raise the temperature to the range of 60 to 80° C., add 4 g of solid sodium chloride, raise the temperature to the range of 80 to 95° C., dropwise add 40 mL of water to prepare a solution with 5.5 g of sodium chloride, control the temperature at the range of 80 to 95° C. after the dropwise addition, hold the temperature for 2 to 6 hours, neutralize it by filtering and washing, and dry it to obtain dark red original dye of vat brown. Add two portions of lignosulfonate per portion of this original dye, and sand for 3 to 6 hours to obtain 20˜30 g of 100% commercial dye. When cotton fabric is dyed by the method given in the application example 1, the fabric is in a bright brown color. It is not only used to dye a single color but also used for color matching of a plurality of dyes. It is an important variety of brown vat dyes.

### Application Example 1

Add one portion of the dye prepared in Embodiment 7, 20 portions of 5 wt % nekal solution and 18 portions of ethanol into a 300 mL of ceramic dye jar, add 2000 portions of reduction liquid containing 0.85 g of sodium hydrosulfite and 1.1 g of NaOH, raise the temperature to 60° C., reduction for 15 minutes, add 50 portions of cotton fabric, and dye it at 60° C. for 45 minutes. Wash and oxidize in the air the fabric, boil it in 0.5 wt % soap lye for 15 minutes, clean it up and dry it naturally to obtain brown dyeing. The strength is 100±3% of that of the standard substance and the shade is similar to that of the standard substance.

### Embodiment 8

A method for producing original dye of vat brown, a. Preparation of 1-amino-5-benzam doanthraquinone: adding 1,5-diaminoanthraquinone acylation mixture (a mixture of 1-amino-5-benzamidoanthraquinone and 1,5-dibenzamidoanthraquinone at a mass ratio of 54:46) into 80 wt % sulfuric acid at 5° C. at a mass ratio of 6:1 between sulfuric acid and 1,5-diaminoanthraquinone acylation mixture, adjusting the temperature of the obtained reaction system to 15° C., holding the temperature for 1 to 4 hours, taking samples, determining the content of 1-amino-5-benzamidoanthraquinone, 1,5-dibenzamidoanthraquinone and 1,5-diaminoanthraquinone by HPLC, identifying the end point of the reaction when the mass percentage of 1,5-dibenzamidoanthraquinone is no more than 5% in the entire system, neutralizing the reaction product by diluting, filtering and washing after arrival at the end point and drying to obtain the hydrolysate; b. Preparation of vat brown R condensate: adding the hydrolysate prepared in the above step into o-dichlorobenzene, raising the temperature to 110° C. for dehydration, adding an acid binding agent, holding the temperature for 0.5 hour, then raising the temperature to 150° C., adding benzoyl chloride, holding the temperature at 150° C. for 1 hour, adding acylated bromide filter cakes (which are 1-benzamido-4-bromoanthraquinone obtained from acylation and bromination of 1-aminoanthraquinone and contains 1-benzamido-4-bromoanthraquinone of no less than 95 wt %) and the acid binding agent, raising temperature to 170° C., then adding copper catalyst, holding the temperature and condensing at 170° C. for 2 hours, taking samples, determining the content by HPLC, identifying the end point of the condensation reaction when the remaining amount of 1-benzamido-4-bromoanthraquinone in the reaction product is no more than 1 wt % and that of 1-amino-5-benzamidoanthraquinone is no more than 1 wt %, removing o-dichlorobenzene through distillation after the condensation, then neutralizing the condensation product by filtering and washing, and drying it to obtain black vat brown R condensate. The amount of the acid binding agent added in the first time is one time of the molar amount of the hydrolysate, the amount of the acid binding agent added in the second time is two times of the molar amount of 1-benzamide-4-bromoanthraquinone, and the acid binding agent is one of sodium carbonate, sodium bicarbonate, potassium carbonate, magnesium oxide, calcium oxide, sodium acetate and pyridine or a mixture of any two of them at any ratio. The molar ratio between 1-benzamido-4-bromoanthraquinone and hydrolysate is 1:1; the molar ratio between 1-benzamido-4-bromoanthraquinone and benzoyl chloride is 4:1; the molar ratio between 1-benzamido-4-bromoanthraquinone and copper catalyst is 1:0.02; and the mass of solvent o-dichlorobenzene is five times of the mass of all materials in the reaction system. c. Preparation of the ring-closed product of vat brown R: adding black vat brown R condensate into 80 wt % sulfuric acid at 5° C. at a mass ratio of 4:1 between sulfuric acid and black vat brown R condensate, adjusting the temperature of the reaction system to 15° C., holding the temperature for 5 hours, then diluting the materials in the reaction system, and neutralizing the reaction product by filtering and washing to obtain the ring-closed product of vat brown R; d. Oxidation step: adding sulfuric acid into water, controlling the concentration of sulfuric acid at 20 wt %, then adding the ring-closed product of vat brown R, mixing and stirring them for 0.5 hour, then raising the temperature to 50° C., adding the oxidizing agent selected from sodium chloride, sodium dichromate and potassium dichromate, then raising the temperature to 80° C., dropwise adding the water solution of the oxidizing agent (the mass ratio between the added oxidizing agent and the ring-closed product of vat brown R is 1:1), holding the temperature for 2 hours, neutralizing the reaction product by filtering and washing, and drying it to obtain dark red original dye of vat brown.

### Embodiment 9

A method for producing original dye of vat brown, a. Preparation of 1-amino-5-benzamidoanthraquinone: adding 1,5-diaminoanthraquinone acylation mixture (a mixture of 1-amino-5-benzamidoanthraquinone and 1,5-dibenzamidoanthraquinone at a mass ratio of 54:46) into 90 wt % sulfuric acid at 10° C. at a mass ratio of 8:1 between sulfuric acid and 1,5-diaminoanthraquinone acylation mixture, adjusting the temperature of the obtained reaction system to 30° C., holding the temperature for 3 hours, taking samples, determining the content of 1-amino-5-benzamidoanthraquinone, 1,5-dibenzamidoanthraquinone and 1,5-diaminoanthraquinone by HPLC, identifying the end point of the reaction when the mass percentage of 1,5-dibenzamidoanthraquinone is no more than 5% in the entire system, neutralizing the reaction product by diluting, filtering and washing after arrival at the end point and drying to obtain the hydrolysate; b. Preparation of vat brown R condensate: adding the hydrolysate prepared in the above step into o-dichlorobenzene, raising temperature to 120° C. for dehydration, adding the acid binding agent, holding the temperature for 1 hour, then raising the temperature to 152° C., adding benzoyl chloride, holding the temperature at 152° C. for 1.5 hours, adding acylated bromide filter cakes (which are 1-benzamido-4-bromoanthraquinone obtained from acylation and bromination of 1-aminoanthraquinone and contains 1-benzamido-4-bromoanthraquinone of no less than 95 wt %) and the acid binding agent, raising temperature to 180° C., adding copper catalyst, holding the temperature at 180° C. and condensing for 4 hours, taking samples, determining the content by HPLC, identifying the end point of the condensation reaction when the remaining amount of 1-benzamido-4-bromoanthraquinone in the reaction product is no more than 1 wt % and that of 1-amino-5-benzamidoanthraquinone is no more than 1 wt %, removing o-dichlorobenzene through distillation after the condensation, then neutralizing the condensation product by filtering and washing, and drying it to obtain black vat brown R condensate. The amount of the acid binding agent added in the first time is two times of the molar amount of the hydrolysate, the amount of the acid binding agent added in the second time is three times of the molar amount of 1-benzamido-4-bromoanthraquinone, and the acid binding agent is one of sodium carbonate, sodium bicarbonate, potassium carbonate, magnesium oxide, calcium oxide, sodium acetate and pyridine or a mixture of any two of them at any ratio. The molar ratio between 1-benzamido-4-bromoanthraquinone and hydrolysate is 1:1.2; the molar ratio between 1-benzamido-4-bromoanthraquinone and benzoyl chloride is 3:1; the molar ratio between 1-benzamido-4-bromoanthraquinone and copper catalyst is 1:0.06; and the mass of solvent o-dichlorobenzene is eight times of the mass of all materials in the reaction system. c. Preparation of the ring-closed product of vat brown R: adding black vat brown R condensate into 90 wt % sulfuric acid at 15° C. at a mass ratio of 5:1 between sulfuric acid and black vat brown R condensate, adjusting the temperature of the reaction system to 25° C., holding the temperature for 8 hours, then diluting the materials in the reaction system, and neutralizing the reaction product by filtering and washing to obtain the ring-closed product of vat brown R; d. Step of oxidation: adding sulfuric acid into water, controlling the concentration of sulfuric acid at 30 wt %, then adding the ring-closed product of vat brown R, mixing and stirring them for 1 hour, then raising the temperature to 60° C., adding oxidizing agent selected from sodium chloride, sodium dichromate and potassium dichromate, then raising the temperature to 85° C., dropwise adding the water solution of the oxidizing agent (the mass ratio between the added oxidizing agent and the ring-closed product of vat brown R is 1:1.5), holding the temperature for 4 hours, neutralizing the reaction product by filtering and washing, and drying it to obtain dark red original dye of vat brown.

### Embodiment 10

A method for producing original dye of vat brown, a. Preparation of 1-amino-5-benzamidoanthraquinone: adding 1,5-diaminoanthraquinone acylation mixture (a mixture of 1-amino-5-benzamidoanthraquinone and 1,5-dibenzamidoanthraquinone at a mass ratio of 54:46) into 98 wt % sulfuric acid at the range of 5 to 15° C. at a mass ratio of 12:1 between sulfuric acid and 1,5-diaminoanthraquinone acylation mixture, adjusting the temperature of the obtained reaction system to 45° C., holding the temperature for 4 hours, taking samples, determining the content of 1-amino-5-benzamidoanthraquinone, 1,5-dibenzamidoanthraquinone and 1,5-diaminoanthraquinone by HPLC, identifying the end point of the reaction when the mass percentage of 1,5-dibenzamidoanthraquinone is no more than 5% in the entire system, neutralizing the reaction product by diluting, filtering and washing after arrival at the end point and drying to obtain the hydrolysate; b. Preparation of vat brown R condensate: adding the hydrolysate prepared in the above step into o-dichlorobenzene, raising temperature to 150° C. for dehydration, adding acid binding agent, holding the temperature for 2 hours, then raising the temperature to 155° C., adding benzoyl chloride, holding the temperature at 155° C. for 2 hours, adding acylated bromide filter cakes (which are 1-benzamido-4-bromoanthraquinone obtained from acylation and bromination of 1-aminoanthraquinone and contains 1-benzamido-4-bromoanthraquinone of no less than 95 wt %) and the acid binding agent, raising temperature to 185° C., adding copper catalyst, holding the temperature at 185° C. and condensing for 6 hours, taking samples, determining the content by HPLC, identifying the end point of the condensation reaction when the remaining amount of 1-benzamido-4-bromoanthraquinone in the reaction product is no more than 1 wt % and that of 1-amino-5-benzamidoanthraquinone is no more than 1 wt %, removing o-dichlorobenzene through distillation after the condensation, then neutralizing the condensation product by filtering and washing, and drying it to obtain black vat brown R condensate. The amount of the acid binding agent added in the first time is three times of the molar amount of the hydrolysate, the amount of the acid binding agent added in the second time is six times of the molar amount of 1-benzamido-4-bromoanthraquinone, and the acid binding agent is one of sodium carbonate, sodium bicarbonate, potassium carbonate, magnesium oxide, calcium oxide, sodium acetate and pyridine or a mixture of any two of them at any ratio. The molar ratio between 1-benzamido-4-bromoanthraquinone and hydrolysate is 1:1.5; the molar ratio between 1-benzamido-4-bromoanthraquinone and benzoyl chloride is 5:1; the molar ratio between 1-benzamido-4-bromoanthraquinone and copper catalyst is 1:0.08; and the mass of solvent o-dichlorobenzene is ten times of the mass of all materials in the reaction system. c. Preparation of the ring-closed product of vat brown R: adding black vat brown R condensate into 98 wt % sulfuric acid at 20° C. at a mass ratio of 8:1 between sulfuric acid and black vat brown R condensate, adjusting the temperature of the reaction system to 35° C., holding the temperature for 10 hours, then diluting the materials in the reaction system, and neutralizing the reaction product by filtering and washing to obtain the ring-closed product of vat brown R; d. Oxidation step: adding sulfuric acid into water, controlling the concentration of sulfuric acid at 40 wt % t, then adding the ring-closed product of vat brown R, mixing and stirring them for 2 hours, then raising the temperature to 80° C., adding oxidizing agent selected from sodium chloride, sodium dichromate or potassium dichromate, then raising the temperature to 95° C., dropwise adding the water solution of the oxidizing agent (the mass ratio between the added oxidizing agent and the ring-closed product of vat brown R is 1:2.5), holding the temperature for 6 hours, neutralizing the reaction product by filtering and washing the reaction product till neutral, and drying it to obtain dark red original dye of vat brown.

What is claimed is:

1. A method for producing original dye of vat brown, wherein it comprises the following steps: a., 1-amino-5-benzamidoanthraquinone is prepared by acidic hydrolysis after acylation of 1,5-diaminoanthraquinone; b. 1-benzamido-4-bromoanthraquinone is obtained from 1-aminoanthraquinone by acylation and bromination; c. a condensate of vat brown R is obtained from the condensation reaction of 1-amino-5-benzamidoanthraquinone and 1-benzamido-4-bromoanthraquinone; d. a original dye of the vat brown R is obtained from the condensate of vat brown R by ring closing reaction and oxidation reaction.

2. A method for producing original dye of vat brown according to claim 1, wherein:
a. Preparation of 1-amino-5-benzamidoanthraquinone: adding 1,5-diaminoanthraquinone acylation mixture into 80˜98 wt % sulfuric acid at a mass ratio of 6˜12:1 between sulfuric acid and 1,5-diaminoanthraquinone acylation mixture, adjusting the temperature of the obtained reaction system to 15 to 45° C., holding the temperature for 1 to 4 hours, taking samples, determining the content of 1-amino-5-benzamidoanthraquinone, 1,5-dibenzamidoanthraquinone and 1,5-diaminoanthraquinone by HPLC, identifying the end point of the reaction when the mass percentage of 1,5-dibenzamidoanthraquinone is no more than 5% in the entire reaction system, neutralizing the reaction product by diluting, filtering and washing after arrival at the end point and drying to obtain the hydrolysate;
b. Preparation of vat brown R condensate: adding the hydrolysate prepared in the above step into o-dichlorobenzene, raising temperature to the range of 110 to 150° C. for dehydration, adding an acid binding agent, holding the temperature for 0.5 to 2 hours, then raising the temperature to the range of 150 to 155° C., adding benzoyl chloride, holding the temperature at the range of 150 to 155° C. for 1 to 2 hours, adding acylated bromide filter cakes (which are 1-benzamido-4-bromoanthraquinone obtained from the acylation and bromination of 1-aminoanthraquinone and contains 1-benzamido-4-bromoanthraquinone of no less than 95 wt % and the acid binding agent, raising temperature to the range of 170 to 185° C., then adding copper catalyst, condensing at the temperature of 170 to 185° C. for 2 to 6 hours, taking samples, determining the content by HPLC, identifying the end point of the condensation reaction when the remaining amount of 1-benzamido-4-bromoanthraquinone in the reaction product is no more than 1 wt % and that of 1-amino-5-benzamidoanthraquinone is no more than 1 wt %, removing o-dichlorobenzene through distillation after the condensation, then neutralizing the condensation product by filtering and washing, and drying it to obtain black vat brown R condensate;
c. Preparation of the ring-closed product of vat brown R: adding black vat brown R condensate into 80˜98 wt % t sulfuric acid, adjusting the temperature of the reaction system to the range of 15 to 35° C., holding the temperature for 5 to 10 hours, then diluting the materials in the reaction system, and neutralizing the reaction product by filtering and washing to obtain the ring-closed product of vat brown R;
d. Step of oxidation: adding sulfuric acid into water, controlling the ring-closed product of vat brown R, mixing and stirring them for 0.5 to 2 hours, then raising the temperature to the range of 50 to 80° C., adding oxidizing agent selected from sodium chloride, sodium dichromate and potassium dichromate, then raising the temperature to the range of 80 to 95° C., dropwise adding the water solution of the oxidizing agent (the mass ratio between the added oxidizing agent and the ring-closed product of vat brown R is 1: (1˜2.5), holding the temperature for 2 to 6 hours, neutralizing the reaction product by filtering and washing, and drying it to obtain dark red original dye of vat brown.

3. A method for producing original dye of vat brown according to claim 2, wherein the 1,5-diaminoanthraquinone acylation mixture is a mixture of 1-amino-5-benzamidoanthraquinone and 1,5-dibenzamidoanthraquinone at a mass ratio of 54: 46.

4. A method for producing original dye of vat brown according to claim 2, wherein in step b, the amount of the acid binding agent added in the first time is 1˜3 times of the molar amount of the hydrolysate, the amount of the acid binding agent added in the second time is 1-6 times of the molar amount of 1-benzamido-4-bromoanthraquinone, and the acid binding agent is one of sodium carbonate, sodium bicarbonate, potassium carbonate, magnesium oxide, calcium oxide, sodium acetate and pyridine or a mixture of any two of them at any ratio.

5. A method for producing original dye of vat brown according to claim 2, wherein in step a, the temperature of sulfuric acid is in the range of 5 to 15° C.

6. A method for producing original dye of vat brown according to claim 2, wherein in step b, the molar ratio between 1-benzamido-4-bromoanthraquinone and hydrolysate is 1: (1˜1.5); the molar ratio between 1-benzamido-4-bromoanthraquinone and benzoyl chloride is not higher than 5:1; the molar ratio between 1-benzamido-4-bromoanthraquinone and copper catalyst is 1: (0.02˜0.08); and the mass of solvent o-dichlorobenzene is 5-10 times of the mass of all the materials in the reaction system.

7. A method for producing original dye of vat brown according to claim 2, wherein in step c, the temperature of sulfuric acid is in the range of 5 to 20° C.

8. A method for producing original dye of vat brown according to claim 2, wherein in step c, the consumption of sulfuric acid is 4˜8 times of the mass of black vat brown R condensate.
